(19) United States
(12) Patent Application Publication
(10) Pub. No.: US 2024/0281141 A1
(43) Pub. Date: Aug. 22, 2024

(54) MEMORY CONTROLLER WITH TIME-BASED READ AND WRITE PHASES

(71) Applicant: Micron Technology, Inc., Boise, ID (US)

(72) Inventors: Patrick A. La Fratta, McKinney, TX (US); Robert Walker, Raleigh, NC (US)

(21) Appl. No.: 18/443,956

(22) Filed: Feb. 16, 2024

Related U.S. Application Data
(60) Provisional application No. 63/446,979, filed on Feb. 20, 2023.

(51) Int. Cl. G06F 3/06

(52) U.S. Cl. CPC G06F 3/0611; G06F 3/0659; G06F 3/0679

(57) ABSTRACT

Better command scheduling in a memory controller can help improve memory device bandwidth utilization. A method for command scheduling in a memory controller can include processing commands of exclusively a first command type from a command queue including transmitting data in a first direction using a data bus for a first duration. Responsive to determining the first duration meets or exceeds a specified time or cycle limit, the bus can be turned around to accommodate transactions or commands of a second type. Following the bus turnaround, the method can include processing commands of exclusively a second command type from the command queue including transmitting data in a second direction using the data bus. The time or cycle limit can be statically or dynamically adjusted, for example, based on a read/write mix of commands in the command queue.

### PRIORITY APPLICATION

This application claims the benefit of priority to U.S. Provisional Application Ser. No. 63/446,979, filed Feb. 20, 2023, which is incorporated herein by reference in its entirety.

### BACKGROUND

Memory devices for computers or other electronic devices may be categorized as volatile and non-volatile memory. Volatile memory requires power to maintain its data, and includes random-access memory (RAM), dynamic random-access memory (DRAM), or synchronous dynamic random-access memory (SDRAM), among others. Non-volatile memory can retain stored data when not powered, and includes flash memory, read-only memory (ROM), electrically erasable programmable ROM (EEPROM), static RAM (SRAM), erasable programmable ROM (EPROM), resistance variable memory, phase-change memory, storage class memory, resistive random-access memory (RRAM), and magnetoresistive random-access memory (MRAM), among others. Persistent memory is an architectural property of the system where the data stored in the media is available after system reset or power-cycling. In some examples, non-volatile memory media may be used to build a system with a persistent memory model.

Memory devices may be coupled to a host (e.g., a host computing device) to store data, commands, and/or instructions for use by the host while the computer or electronic system is operating. For example, data, commands, and/or instructions can be transferred between the host and the memory device(s) during operation of a computing or other electronic system.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates generally a block diagram of an example computing system including a host and a memory device.

FIG. 2 illustrates generally a block diagram of a first memory controller.

FIG. 3 illustrates generally an example of a second memory controller.

FIG. 4 illustrates generally an example of a method that can include or use time-based phases for accessing a memory device.

FIG. 5 illustrates generally an example of a method that can include updating a command phase time limit.

FIG. 6 illustrates generally an example of a method that can include processing exceptions to time-based command phase control in a memory controller.

FIG. 7 illustrates a block diagram of an example machine with which, in which, or by which any one or more of the techniques discussed herein can be implemented.

### DETAILED DESCRIPTION

Aspects of the present disclosure are directed to increasing the bandwidth for command scheduling in memory subsystems. A memory subsystem is also hereinafter referred to as a “memory device.” An example of a memory subsystem is a storage system, such as a solid-state drive (SSD). In some embodiments, the memory subsystem is a hybrid memory/storage subsystem. In general, a host system can use a memory subsystem that includes one or more memory components. The host system can provide data to be stored at the memory subsystem and can request data to be retrieved from the memory subsystem.

The memory subsystem can include multiple memory components that can store data from the host system. In an effort to reduce the latency experienced by the host system, the memory subsystem can implement command scheduling policies to prioritize or establish an order for particular commands. One example of a command scheduling policy is a first-ready, first-come, first-serve (FRFCFS) policy or a FRFCFS policy with read priority. To implement a basic FRFCFS policy with read priority, the memory subsystem inserts read commands to open rows into the highest priority queue (e.g., queue 0), reads commands to closed rows into the second highest priority queue (e.g., queue −1), writes commands to open rows into the third highest priority queue (e.g., queue −2), and writes commands to closed rows into the fourth highest priority queue (e.g., queue −3). The memory subsystem will search the first and second highest priority queues (e.g., queue 0, −1) for a ready command and select for issuance the first ready command that is found. If there are no commands in the first and second highest priority queues (e.g., queue 0, −1), the memory subsystem searches in the third and fourth highest priority queues (e.g., queue −2, −3) for a ready command and selects for issuance the first ready command that is found.

A conventional memory subsystem that strictly enforces an FRFCFS policy with read priority can have the effect of substantially reducing the overall bandwidth. For example, strict implementation of an FRFCFS policy with read priority can cause a conventional memory subsystem to empty the command queue of all read commands, leaving only write commands in the command queue. When a later read command enters the command queue, the conventional memory subsystem will stop issuing write commands to issue the read command, and then return to issuing the write commands. Switching from issuing write commands to read commands and vice-versa is referred to as “turning the bus around” and there is a latency (time) penalty associated with turning the bus around. Thus, each time the conventional memory subsystem issues a read command in isolation, the bus turnaround penalty will be incurred twice, which in turn decreases the bandwidth or utilization of the bus. Similarly, implementing a strict FRFCFS policy with read priority, a conventional memory subsystem may fail to address the read commands of read-modify-writes (RMW) and accordingly bandwidth suffers due to the bus turnaround penalty.

Further, in implementing a strict FRFCFS policy with read priority, when there are multiple outstanding write commands that access the same bank as a read command but at a different row, the conventional memory subsystem will close the write command's row to open the row associated with the read command. After the read command is completed, the conventional memory subsystem then closes the row associated with the read command and reopens the write command's row to continue issuing the write commands. The penalties associated with the extra row commands further reduces the overall bandwidth.

In an example, a conventional memory subsystem implementing a strict FRFCFS policy with read priority will issue write commands by prioritizing the ready write commands by order of their arrival in the command queue, for example, without considering the particular memory components being accessed or the readiness of other commands in the queue. This can lead to poor overall bandwidth when accessing memory components that require large durations of time between a write command and another command to the same partition or bank (e.g., a logical unit of storage in a memory component).

Aspects of the present disclosure address the above-described and other problems or deficiencies using a scheduling policy that uses time-based read and write phases. The present inventors have recognized that a scheduling policy with time-based read and write phases can help reduce the number of bus turnarounds, which in turn results in less data bus idle times and higher data bus utilization. The present inventors have recognized that the time-based scheduling policy can be implemented together with, or can be used to augment, an FRFCFS policy or a FRFCFS policy with read priority. The present inventors have further recognized that the time-based scheduling policy can include or use configurable duration parameters for read and write phases, such as can have static values or can be dynamically updated.

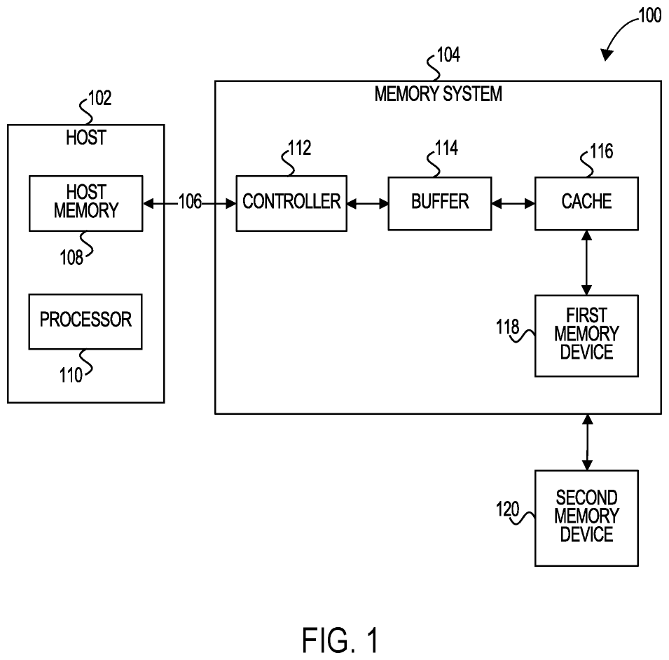

FIG. 1 illustrates generally a block diagram of an example of a computing system 100 including a host device 102 and a memory system 104. The host device 102 includes a central processing unit (CPU) or processor 110 and a host memory 108. In an example, the host device 102 can include a host system such as a personal computer, a desktop computer, a digital camera, a smart phone, a memory card reader, and/or Internet-of-things enabled device, among various other types of hosts, and can include a memory access device, e.g., the processor 110. The processor 110 can include one or more processor cores, a system of parallel processors, or other CPU arrangement.

The memory system 104 includes a controller 112, a buffer 114, a cache 116, and a first memory device 118. The first memory device 118 can include, for example, one or more memory modules (e.g., single in-line memory modules, dual in-line memory modules, etc.). The first memory device 118 can include volatile memory and/or non-volatile memory, and can include a multiple-chip device that comprises one or multiple different memory types or modules. In an example, the computing system 100 includes a second memory device 120 that interfaces with the memory system 104 and the host device 102.

The host device 102 can include a system backplane and can include a number of processing resources (e.g., one or more processors, microprocessors, or some other type of controlling circuitry). The computing system 100 can optionally include separate integrated circuits for the host device 102, the memory system 104, the controller 112, the buffer 114, the cache 116, the first memory device 118, the second memory device 120, any one or more of which may comprise respective chiplets that can be connected and used together. In an example, the computing system 100 includes a server system and/or a high-performance computing (HPC) system and/or a portion thereof. Although the example shown in FIG. 1 illustrates a system having a Von Neumann architecture, embodiments of the present disclosure can be implemented in non-Von Neumann architectures, which may not include one or more components (e.g., CPU, ALU, etc.) often associated with a Von Neumann architecture.

In an example, the first memory device 118 can provide a main memory for the computing system 100, or the first memory device 118 can comprise accessory memory or storage for use by the computing system 100. In an example, the first memory device 118 or the second memory device 120 includes one or more arrays of memory cells, e.g., volatile and/or non-volatile memory cells. The arrays can be flash arrays with a NAND architecture, for example. Embodiments are not limited to a particular type of memory device. For instance, the memory devices can include RAM, ROM, DRAM, SDRAM, PCRAM, RRAM, and flash memory, among others.

In embodiments in which the first memory device 118 includes persistent or non-volatile memory, the first memory device 118 can include a flash memory device such as a NAND or NOR flash memory device. The first memory device 118 can include other non-volatile memory devices such as non-volatile random-access memory devices (e.g., NVRAM, ReRAM, FeRAM, MRAM, PCM), memory devices such as a ferroelectric RAM device that includes ferroelectric capacitors that can exhibit hysteresis characteristics, a 3-D Crosspoint (3D XP) memory device, etc., or combinations thereof.

In an example, the controller 112 comprises a media controller such as a non-volatile memory express (NVMe) controller. The controller 112 can be configured to perform operations such as copy, write, read, error correct, etc. for the first memory device 118. In an example, the controller 112 can include purpose-built circuitry and/or instructions to perform various operations. That is, in some embodiments, the controller 112 can include circuitry and/or can be configured to perform instructions to control movement of data and/or addresses associated with data such as among the buffer 114, the cache 116, and/or the first memory device 118 or the second memory device 120.

In an example, at least one of the processor 110 and the controller 112 comprises a command manager (CM) for the memory system 104. The CM can receive, such as from the host device 102, a read command for a particular logic row address in the first memory device 118 or the second memory device 120. In some examples, the CM can determine that the logical row address is associated with a first row based at least in part on a pointer stored in a register of the controller 112. In an example, the CM can receive, from the host device 102, a write command for a logical row address, and the write command can be associated with second data. In some examples, the CM can be configured to issue, to non-volatile memory and between issuing the read command and the write command, an access command associated with the first memory device 118 or the second memory device 120. In some examples, the CM can issue, to the non-volatile memory and between issuing the read command and the write command, an access command associated with the first memory device 118 or the second memory device 120.

In an example, the buffer 114 comprises a data buffer circuit that includes a region of a physical memory used to temporarily store data, for example, while the data is moved from one place to another. The buffer 114 can include a first-in, first-out (FIFO) buffer in which the oldest (e.g., the first-in) data is processed first. In some embodiments, the buffer 114 includes a hardware shift register, a circular buffer, or a list.

In an example, the cache 116 comprises a region of a physical memory used to temporarily store particular data that is likely to be used again. The cache 116 can include a pool of data entries. In some examples, the cache 116 can be configured to operate according to a write-back policy in which data is written to the cache without being concurrently written to the first memory device 118. Accordingly, in some embodiments, data written to the cache 116 may not have a corresponding data entry in the first memory device 118.

In an example, the controller 112 can receive write requests (e.g., from the host device 102) involving the cache 116 and cause data associated with each of the write requests to be written to the cache 116. In some examples, the controller 112 can receive the write requests at a rate of thirty-two (32) gigatransfers (GT) per second, such as according to or using a CXL protocol. The controller 112 can similarly receive read requests and cause data stored in, e.g., the first memory device 118 or the second memory device 120, to be retrieved and written to, for example, the host device 102 via an interface 106.

In an example, the interface 106 can include any type of communication path, bus, or the like that allows information to be transferred between the host device 102 and the memory system 104. Non-limiting examples of interfaces can include a peripheral component interconnect (PCI) interface, a peripheral component interconnect express (PCIe) interface, a serial advanced technology attachment (SATA) interface, and/or a miniature serial advanced technology attachment (mSATA) interface, among others. In an example, the interface 106 includes a PCIe 5.0 interface that is compliant with the compute express link (CXL) protocol standard. Accordingly, in some embodiments, the interface 106 supports transfer speeds of at least 32 GT/s.

In an example, the controller 112 can be configured to implement a command selection policy. Examples of command selection policies include FCFS (first-come, first-served) and FRFCFS (first-ready, first-come, first-served). A FCFS policy can include scheduling commands received (e.g., from the host device 102) to a memory controller (e.g., to the controller 112) for execution by a memory device (e.g., a main memory such as a DRAM device) based on the order in which the commands were received by (e.g., decoded by) the controller. Therefore, the oldest commands are executed first. However, various memory systems include timing constraints that can affect whether a command can be issued (e.g., from the memory controller to the memory device). For example, various support circuitry associated with a memory array (e.g., row decode circuitry, column decode circuitry, sense amplifier circuitry, precharge circuitry, refresh circuitry, etc.) can include timing constraints that determine when or if a particular command is ready for execution by the memory device. Accordingly, a FCFS policy can increase execution latency because a newer command may be ready for issuance to the memory device (e.g., based on the timing constraints) but the command cannot be sent to the memory device until the older command is executed.

An FRFCFS policy can reduce latency as compared to a FCFS policy. For example, in the FRFCFS policy, a memory controller may iterate through the command queue and select the first command it encounters that is ready to be issued. Therefore, an older command which is not yet ready may be skipped over in favor of a newer pending command that is ready.

As an example, a FRFCFS policy may include prioritizing column commands over row commands such that the policy includes searching the command queue for the oldest column command ready to be issued and if an issuable column command is not found, the oldest row command that is ready to be issued is selected for issuance to the memory device. Memory and storage arrays may be organized logically or physically, or both, in columns and rows. As used herein, a “column” command refers to a command directed to an address corresponding to an open (e.g., activated) row (e.g., page) of an array of the memory device, and a “row” command refers to a command directed to an address corresponding to a closed (e.g., deactivated) row of the array.

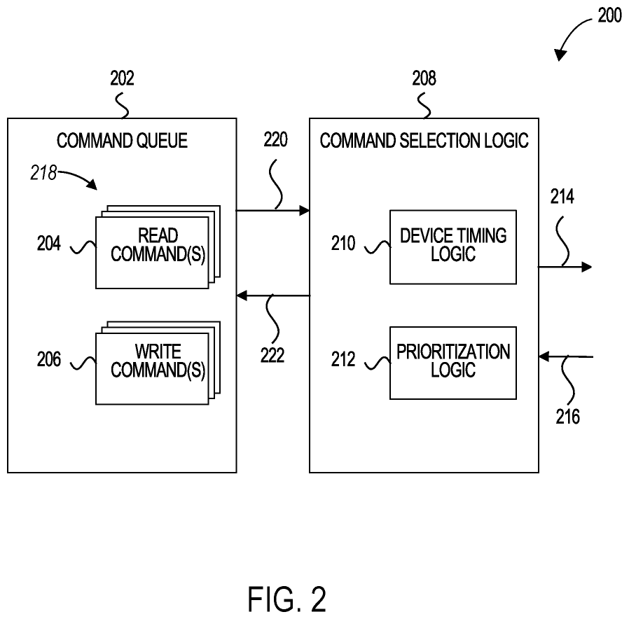

FIG. 2 illustrates generally a block diagram of a first controller 200 configured to implement a command selection policy in accordance with various embodiments. The first controller 200 can be a portion of a controller such as the controller 112 in the example of FIG. 1. In an example, the first controller 200 can comprise a command selection subsystem of the controller 112 that is used to implement a particular command selection policy. As used herein, a command selection policy may be referred to as a command scheduling policy and can refer to selecting commands and/or scheduling (e.g., prioritizing, ordering, etc.) commands for issuance to a memory device or group of devices.

The first controller 200 includes a command queue 202 that stores various commands, such as one or more read command(s) 204 and one or more write command(s) 206, referred to collectively as commands 218 associated with requests to a memory system, such as received from a host device. The first controller 200 can decode incoming requests and categorize the corresponding commands 218 in accordance with a desired command selection policy.

In the example of FIG. 2, the first controller 200 includes command selection logic 208. The command selection logic 208 can be configured to implement a desired command selection policy, such as for a received command 220. In this example, the command selection logic 208 includes device timing logic 210 and other prioritization logic 212 used to implement a command selection policy. A selected command 214 can be sent to the memory device and a response 216 (e.g., corresponding to the selected command) can be returned from the memory device. In an example, other control signal(s) 222 can represent commands or other communication from the command selection logic 208 to help manage the commands 218, such as can include instructions to remove commands from particular queues after issuances to the memory device.

In an example, the device timing logic 210 can be configured to track timing constraints associated with accessing a memory device to which commands will be issued. Such timing constraints can include timing of various control signals (e.g., read/write enable signals) and/or address signals (e.g., row/column address signals), among others. For example, if the memory device is a DRAM device, timing constraints can include a minimum time required between an activate command and a column command (e.g., tRCD), a minimum time required between column commands (e.g., tCCD), a minimum time between a precharge command and an activate command (e.g., tRP), among other timing parameters (e.g., tRAS, tCAS, tCP, tASR, tASC, tCAH, etc.). In an example, the device timing logic 210 can be used to determine whether commands are ready to issue (e.g., whether the commands can be sent to the memory device for execution without violating the device timing parameters). As used herein, the term “queue” is not intended to be limited to a specific data structure implementation, but rather the term queue can refer to a collection of elements organized in various manners and which can have characteristics of one or more different types of queues and/or lists (e.g., a list, a linked list, etc.), among others.

The prioritization logic 212 can be configured to iterate through the commands 218 in the command queue 202 and determine, for example, categories for the commands 218. For example, the prioritization logic 212 can categorize the commands 218 based on various factors including, but not limited to, command type (e.g., read or write), command address (e.g., whether the command targets an open or closed row of the memory device), and/or command age (e.g., time since being received), among other factors such as a relationship of one command to another (e.g., a read-after-write dependency).

The command selection logic 208 can be configured to enforce various scheduling schemes or queue priorities. Queues having different priorities may be referred to as having a first priority, a second priority, a third priority, and the like. The difference in priority of one queue is relative to another queue. A priority order of particular commands 218 can be based on, for example, an age of the commands such that the oldest command has a highest priority and will be encountered first when iterating through the respective queue. As an example, iterating through at least some of the queues can include using a FRFCFS policy in which a first command ready for issuance (e.g., based on the device timing parameters) that is encountered is selected for issuance.

In an example, if the command queue 202 includes commands having only one type or category (e.g., the command queue 202 includes all read commands or all write commands), then the first controller 200 can saturate the data bus by sending commands without gaps (i.e., idle cycles) in the data bus activity. That is, the data bus can be fully utilized if bus turnarounds are not needed, for example, in switching between issuance of read commands and write commands.

The high performance and utilization can be contrasted with cases in which the first controller 200 sends or uses a mix of read commands and write commands. Large bus turnaround penalties can be incurred by memory devices which thereby reduce data bus utilization significantly. In an example, a read-to-write turnaround penalty can include multiple idle cycles (e.g., 9 cycles) between a read command and a following write command using the same data bus or channel. This results in idle data bus cycles following initial data bus activation, representing a reduction from cases that don't require turning the bus around. The penalty can be worse for the read-after-write case. For example, the penalty can be a minimum of, e.g., 23 cycles of separation between the write command and the following read command, which results in 22 idle data bus cycles out of the 30 cycles following the initial activation of the data bus.

A conventional command scheduling policy such as FRFCFS, not having been designed with specific consideration of avoiding turnaround penalties, may incidentally incur such penalties in ways that are detrimental to performance. The FRFCFS scheduling policy is designed to give highest priority to commands that become issuable first or earliest. This implies that the scheduling logic will opportunistically schedule a read or write as one becomes available, even if doing so results in increased bus turnarounds. In an example, a simulation of 10k requests with a randomized, 50% read/write mix through a controller configured to use FRFCFS turned the bus around 191 times and showed about 73% bus utilization.

FRFCFS with read priority is based on FRFCFS but is designed to give highest priority to read commands. While this scheduling policy tends to reduce read latency and can increase performance for applications that are latency-sensitive, it can result in even greater numbers of turnarounds than pure FRFCFS. One reason is that this policy favors reads so strongly that it tends to issue all read commands available, leaving only write commands in the queue. The controller will then turn the bus around and begin issuing writes. After a read command arrives, the controller will try to immediately issue the read command, which can result in two bus turnarounds: one to issue the read command and another to resume issuing the write commands. In an example, a simulation of 10k requests with a randomized, 50% read/write mix through a controller configured to use FRFCFS with read priority turned the bus around 242 times and achieved about 70% bus utilization.

Various embodiments of the present disclosure implement a modified FRFCFS command selection policy using time-based read and write phases. For example, the modified FRFCFS command selection policy can include or use read commands (e.g., both column read commands and row read commands) during a particular designated time duration or interval, and can include or use write commands (e.g., both column write commands and row write commands), during another designated time duration or interval. Some examples can accommodate interruptions or changes in the phases when the queue does not include commands of the type designated for a particular phase. The time-based command selection policy can provide improved system performance (e.g., via reduced latency) as compared to various other selection policies.

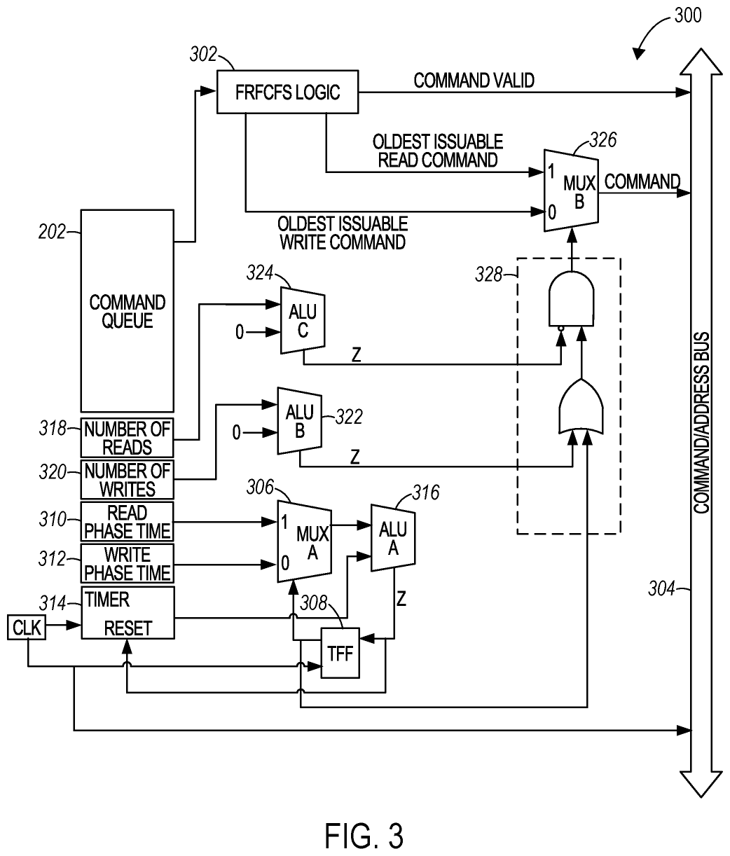

FIG. 3 illustrates generally an example of a second controller 300, such as can be configured to implement a modified FRFCFS command selection policy. In an example, the second controller 300 implements the command selection logic 208 using time-based read and write phases for read commands and write commands, respectively, from the command queue 202. Parameters in or used by the second controller 300 can be programmed or set (e.g., by a user or automatically by a processor in response to run-time or other activities) to specify a period of time during which the controller issues exclusively read commands to the memory device (i.e., without turning the bus around between consecutive read commands) and a different period of time during which the controller issues exclusively write commands to the memory device (i.e., without turning the bus around between consecutive write commands).

The example of FIG. 3 includes a read phase register 310 and a write phase register 312. The read phase register 310 can store information indicating a time (e.g., represented as a time duration, or as a number of clock cycles) for the second controller 300 to use for a read phase during which the controller issues read commands. The write phase register 312 can store information indicating a time (e.g., represented as a time duration, or as a number of clock cycles) for the second controller 300 to use for a write phase during which the controller issues write commands.

In the example of FIG. 3, the command queue 202 (e.g., comprising one or more read commands and/or one or more write commands) provides commands to FRFCFS logic 302. The FRFCFS logic 302 is configured to implement an FRFCFS policy to select particular next commands from the command queue 202 to provide to a memory device using, e.g., a data bus 304. For example, FRFCFS logic 302 provides an oldest issuable read command (or next read command) to a first input of a command multiplexer circuit 326 and provides an oldest issuable write command (or next write command) to a second input of the command multiplexer circuit 326, and the command multiplexer circuit 326 selects which command to provide to the memory device using the data bus 304. The command multiplexer circuit 326 can receive a command multiplexer control signal from a phase-indicating flip-flop circuit 308. The command multiplexer control signal can indicate which of the commands from the FRFCFS logic 302 to provide to the memory device.

In an example, an output signal from the flip-flop circuit 308 is a binary signal that indicates whether a present phase for the second controller 300 is a read phase or a write phase. For example, when the output signal from the flip-flop circuit 308 is 0 then the command multiplexer circuit 326 selects the oldest issuable write command and the second controller 300 is configured to operate in a write phase, and when the output signal from the flip-flop circuit 308 is 1 then the command multiplexer circuit 326 selects the oldest issuable read command and the second controller 300 is configured to operate in a read phase.

In an example, a state of the flip-flop circuit 308 is configured to be controlled based on a relationship between an elapsed time and a time limit. The elapsed time can be measured, for example, using a timer circuit 314. The elapsed time can indicate a time duration or a count of a number of clock cycles (e.g., a counter value) from a clock signal source that provides a clock signal CLK to the second controller 300.

The time limit can be a read phase time limit, such as can be read from a read phase register 310, or a write phase time limit, such as can be read from a write phase register 312. In an example, the time limit information in the registers indicates a number of cycles to be allotted for each of a read phase and a write phase for the second controller 300. The time limit information in the registers can be set or programmed to have a static value or can be updated dynamically or periodically, for example, based on run-time conditions.

In an example, processing circuitry can be configured to monitor the command mix, or relative number of read commands to write commands, in the command queue 202 and can correspondingly adjust the values in the read phase register 310 or the write phase register 312. For example, if incoming commands are biased or weighted toward read commands, then more time can be allotted to a present or subsequent read phase and the time or count value stored in the read phase register 310 can be increased. By contrast, if more incoming commands are write commands than read commands, then more time can be allotted to one or more subsequent write phases and the value stored in the write phase register 312 can be correspondingly adjusted. Additionally or alternatively, the processing circuitry can be configured to use information about a read-to-write or write-to-read timing constraint for the second controller 300 or the memory device coupled to the second controller 300. In this example, system performance may be improved by setting one of the read or write phase duration to be longer than the other to help mitigate any imbalance in bus turnaround penalties.

In an example, the second controller 300 includes a phase multiplexer circuit 306 that is configured to read or receive information from the read phase register 310 and the write phase register 312. The phase multiplexer circuit 306 can select a particular one of the information from the read phase register 310 and the write phase register 312 for comparison with the elapsed time (e.g., as measured by the timer circuit 314) based on phase state information in the output signal from the flip-flop circuit 308. In other words, the output signal of the flip-flop circuit 308 can control which of the read phase time limit or the write phase time limit is selected by the phase multiplexer circuit 306 for comparison with an elapsed time. In the example of FIG. 3, the comparison is performed by a first ALU circuit 316. If the first ALU circuit 316 determines that the elapsed time is equal to the selected time limit, then an output of the first ALU circuit 316 can trigger or cause a state change of the flip-flop circuit 308 and its phase-indicating output signal, and can reset the timer circuit 314 to measure an elapsed time for a subsequent phase. Other techniques, logic, and circuits can similarly be used to determine when a particular time duration elapses and cause a change in read/write phase for the second controller 300.

In an example, the second controller 300 can include circuitry configured to handle exceptions. For example, the second controller 300 can include interrupt logic 328 configured to receive or intercept the output signal from the flip-flop circuit 308, process the output signal from the flip-flop circuit 308 according to one or more interrupt conditions, and then provide the command multiplexer control signal to the command multiplexer circuit 326. For example, the interrupt logic 328 is configured to interrupt a read phase when no read commands are in the command queue 202, and to interrupt a write phase when no write commands are in the command queue 202.

The interrupt logic 328 can receive signals from the flip-flop circuit 308 and from other logic signal sources that are configured to indicate whether read commands or write commands are present in the command queue 202. For example, the second controller 300 can include a read command count register 318 that indicates a number of read commands pending in the command queue 202, and can include a write command count register 320 that indicates a number of write commands pending in the command queue 202. A second ALU circuit 322 can be configured to provide a logic high signal when the write command count register 320 indicates zero pending write commands and provide a logic low signal when the write command count register 320 indicates a non-zero number of pending write commands. A third ALU circuit 324 can be configured to provide a logic high signal when the read command count register 318 indicates zero pending read commands and provide a logic low signal when the read command count register 318 indicates a non-zero number of pending read commands. The interrupt logic 328 can receive the logic signals from the second ALU circuit 322 and the third ALU circuit 324 and the flip-flop circuit 308 and, in response, provide the command multiplexer control signal to the command multiplexer circuit 326.

In the example of FIG. 3, the interrupt logic 328 can include a first OR gate that is configured to receive and compare logic output signals from the flip-flop circuit 308 and from the second ALU circuit 322. If at least one of the output signal from the flip-flop circuit 308 indicates a read phase or the output signal from the second ALU circuit 322 indicates there are zero write commands in the command queue 202, then the output of the first OR gate will be logic high or 1 (e.g., tentatively indicating a read phase for the second controller 300). Otherwise, the output of the first OR gate will be logic low or 0 (e.g., tentatively indicating a write phase for the second controller 300). The interrupt logic 328 can include a first AND gate that is configured to receive and compare a logic output signal from the first OR gate and an inverted logic output from the third ALU circuit 324. The output of the first AND gate will be logic high or 1 to indicate a read phase only when the output of the first OR gate is logic high and when there is a non-zero number of read commands in the command queue 202, and accordingly the interrupt logic 328 can provide the command multiplexer control signal to the command multiplexer circuit 326 to select the read phase for the second controller 300. If, during the read phase, a number of read commands in the command queue 202 reaches zero, then the output of the third ALU circuit 324 is inverted and the state of the command multiplexer control signal changes to select the write phase. Other logic circuitry can be similarly provided to test for commands of a particular type in the command queue 202 and correspondingly control the command multiplexer circuit 326 to implement a read phase or a write phase, or to transition between phases when fewer than a threshold number of commands of a particular type are present in the command queue 202.

In an example, the interrupt logic 328 can process an exception to change the second controller 300 phase before expiration of the timer circuit 314. In some examples, after handling of the exception (e.g., including turning the bus around to process one or more write commands during a read phase, or vice versa), the second controller 300 can turn the bus around again and revert to the original phase for the remainder of the duration indicated in the time register (e.g., the read phase register 310 or the write phase register 312), or can remain in the phase indicated by the exception unless or until interrupted again. In some examples, the timer circuit 314 can be reset in coordination with an exception or the timer circuit 314 can be allowed to continue counting until a reset is indicated by the first ALU circuit 316. In some examples, other adjustments can be made to the count or duration measured by the timer circuit 314 in coordination with an exception, for example, by increasing or decreasing the amount of time allotted for a present or future phase. In other examples, processing circuitry can be used to monitor a number of exceptions issued and, in response, update or adjust the values stored in the read phase register 310 or the write phase register 312 to thereby adjust subsequent phase durations.

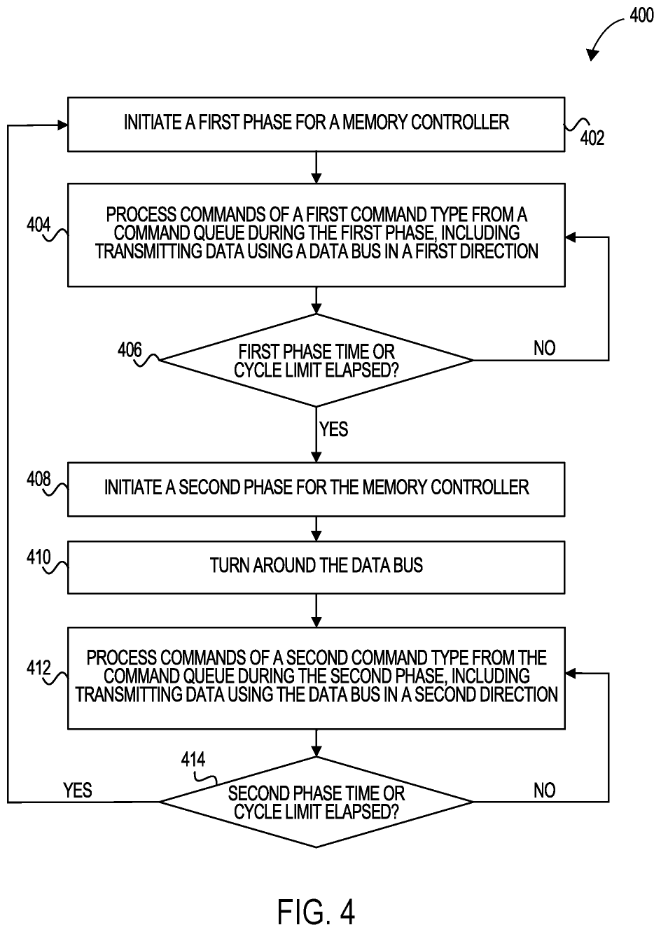

FIG. 4 illustrates generally an example of a first method 400 that can include or use time-based phases for accessing a memory device using a memory controller, such as the second controller 300. At operation 402, the first method 400 can include initiating a first phase for a memory controller. The first phase can include one of a read phase during which read commands are provided from the controller to a memory device, or a write phase during which write commands are provided from the controller to the memory device. The phase can indicate which direction data travels along a data bus. In some examples, changing phase can correspond to a time penalty due to one or more idle cycles provided between read or write operations.

At operation 404, the first method 400 can include processing commands of a first command type (e.g., read commands or write commands) using the second controller 300 and the memory device. The commands can be retrieved or received from a command queue, such as the command queue 202 from the example of FIG. 3. In an example, operation 404 includes processing exclusively commands of the first command type. Operation 404 can include transmitting data in a first direction between the second controller 300 and the memory device using the data bus. In an example, processing a particular command at operation 404 includes removing the particular command from the command queue 202 to make available one or more subsequent or new commands (e.g., of the same or different command type).

At decision operation 406, the first method 400 includes determining whether a first phase time limit or cycle limit elapsed for the first phase. Information about the duration of the limit can be retrieved, for example, from respective data registers that are coupled to the second controller 300. In an example, if the elapsed time of the first phase has not reached the limit, then the first method 400 returns to operation 404 and processes other commands of the first command type from the command queue. If the elapsed time of the first phase has reached the limit, then the first method 400 continues at operation 408.

At operation 408, the first method 400 can include initiating a second phase for the memory controller. Initiating the second phase can include initiating a phase that is different than, or opposite to, the first phase. For example, if the first phase is a read phase, then the second phase can be a write phase. At operation 410, the first method 400 includes turning around the data bus to accommodate operations for the second phase, for example, from the first direction to a second direction.

At operation 412, the first method 400 includes processing commands of the second command type using the second controller 300 and the memory device. Operation 412 can include transmitting data in the second direction between the second controller 300 and the memory device using the data bus.

At decision operation 414, the first method 400 includes determining whether a second phase time limit or cycle limit elapsed for the second phase. In an example, if the elapsed time of the second phase has not reached the limit, then the first method 400 returns to operation 412 and processes other commands of the second command type from the command queue. If the elapsed time of the second phase has reached the limit, then the first method 400 continues at operation 402.

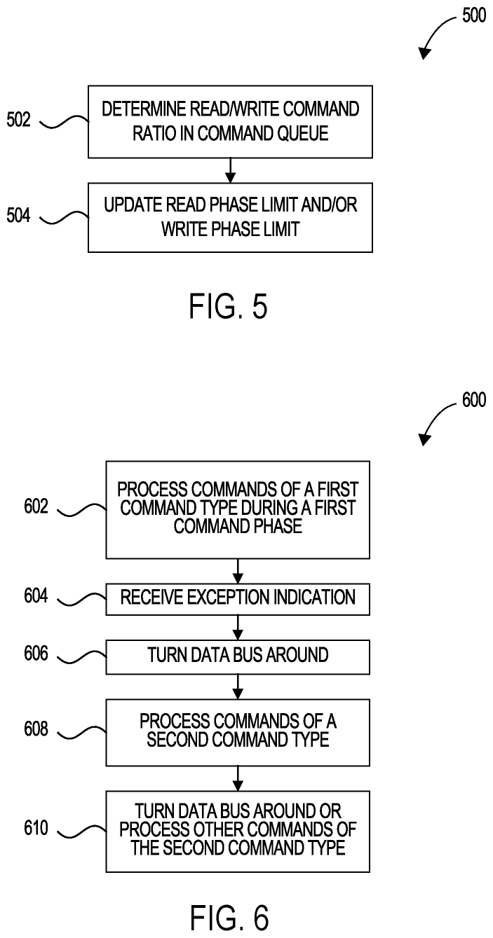

FIG. 5 illustrates generally an example of a second method 500 that can include updating command phase limit information, such as for read and/or write phase time or cycle limits for the second controller 300. At operation 502, the second method 500 includes determining a command type mix, or population of a command queue based on types of commands in the queue. For example, operation 502 can include determining a number or amount of read commands and write commands in the command queue 202, such as can be expressed as a read/write (or write/read) command ratio or percentage. In an example, operation 502 can additionally or alternatively include determining a number or amount of read and/or write commands that are issued to the second controller 300, for example, by a host device, such as at or over a particular duration of time.

Based on the mix of command types, the second method 500 can include updating a phase limit at operation 504. For example, operation 504 can include updating a value of a time limit or a cycle count limit that is stored in the read phase register 310 or the write phase register 312. In an example, the registers can hold information about different time or cycle limits or can have the same values. In an example, if the same time or cycle limit value is used for each of the read and write phases, then one central register can be used to store the value.

FIG. 6 illustrates generally an example of a third method 600 that can include processing exceptions to time-based command phase control in a memory controller such as the second controller 300. At operation 602, the third method 600 can include processing commands of a first command type during a first command phase. For example, the first command type can include read commands exclusive of write commands (i.e., the first command type can correspond to read commands only).

At operation 604, the third method 600 can include receiving an exception indication. In an example, the exception indication can indicate that commands of the first command type are unavailable. For example, the exception can indicate that the command queue 202 is unoccupied by read commands during the first command phase. In an example, the exception indication can include information about whether an unprocessed read command or an unprocessed write command is available in the command queue 202.

In response to receiving the exception indication, the third method 600 can include turning the data bus around at operation 606. In an example, operation 606 incurs a time-based penalty of one or more clock cycles. The extent of the penalty can depend upon, for example, the configuration of the particular memory device used with the second controller 300. At operation 608, following the bus turnaround, the third method 600 can include processing commands of a second command type, for example, including one or more write commands. Following operation 608, there may or may not be other write commands in the queue, or a time allocated for the turned-around data bus may expire. At operation 610, the third method 600 can include turning the data bus around again, such as to return to processing commands of the first command type, for any remainder of the first command phase. In an example, operation 610 can alternatively include maintaining the bus in the configuration to process other commands of the second command type. Other conditions can similarly be used to determine when or whether to turn the bus around again, for example, if the command queue 202 is unoccupied by one or more particular types of commands.

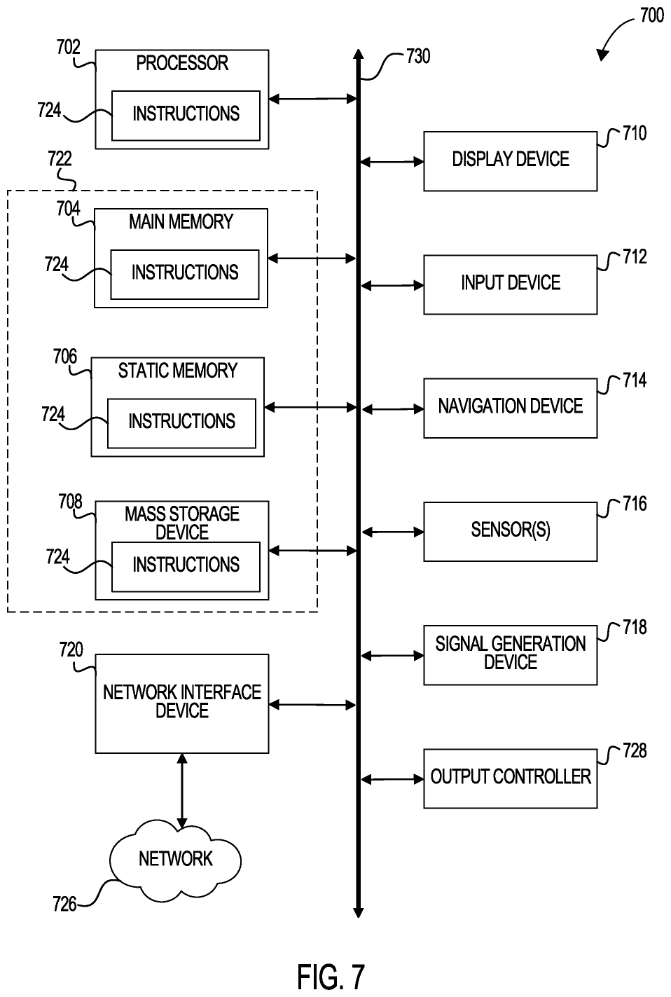

FIG. 7 illustrates a block diagram of an example machine 700 with which, in which, or by which any one or more of the techniques (e.g., methodologies) discussed herein can be implemented. Examples, as described herein, can include, or can operate by, logic or a number of components, or mechanisms in the machine 700. Circuitry (e.g., processing circuitry) is a collection of circuits implemented in tangible entities of the machine 700 that include hardware (e.g., simple circuits, gates, logic, etc.). Circuitry membership (e.g., as belonging to a host-side device or process, or to an accelerator-side device or process) can be flexible over time. Circuitries include members that can, alone or in combination, perform specified operations when operating. In an example, hardware of the circuitry can be immutably designed to carry out a specific operation (e.g., hardwired) for example using a specific command execution unit thereof. In an example, the hardware of the circuitry can include variably connected physical components (e.g., command execution units, transistors, simple circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine-readable medium elements are part of the circuitry or are communicatively coupled to the other components of the circuitry when the device is operating. In an example, any of the physical components can be used in more than one member of more than one circuitry. For example, under operation, execution units can be used in a first circuit of a first circuitry at one point in time and reused by a second circuit in the first circuitry, or by a third circuit in a second circuitry at a different time.

In alternative embodiments, the machine 700 can operate as a standalone device or can be connected (e.g., networked) to other machines. In a networked deployment, the machine 700 can operate in the capacity of a server machine, a client machine, or both in server-client network environments. In an example, the machine 700 can act as a peer machine in a peer-to-peer (P2P) (or other distributed) network environment. The machine 700 can be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Any one or more of the components of the machine 700 can include or use one or more instances of the host device 102 or the memory system 104 or other component in or appurtenant to the computing system 100. The machine 700 (e.g., computer system) can include a hardware processor 702 (e.g., the host processor 110, the controller 112, the command selection logic 208, the second controller 300, etc., a central processing unit (CPU), a graphics processing unit (GPU), a hardware processor core, or any combination thereof), a main memory 704, a static memory 706 (e.g., memory or storage for firmware, microcode, a basic-input-output (BIOS), unified extensible firmware interface (UEFI), etc.), and mass storage device 708 or memory die stack, hard drives, tape drives, flash storage, or other block devices) some or all of which can communicate with each other via an interlink 730 (e.g., bus). The machine 700 can further include a display device 710, an alphanumeric input device 712 (e.g., a keyboard), and a user interface (UI) Navigation device 714 (e.g., a mouse). In an example, the display device 710, the input device 712, and the UI navigation device 714 can be a touch screen display. The machine 700 can additionally include a mass storage device 708 (e.g., a drive unit), a signal generation device 718 (e.g., a speaker), a network interface device 720, and one or more sensor(s) 716, such as a global positioning system (GPS) sensor, compass, accelerometer, or other sensor. The machine 700 can include an output controller 728, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the hardware processor 702, the main memory 704, the static memory 706, or the mass storage device 708 can be, or include, a machine-readable media 722 on which is stored one or more sets of data structures or instructions 724 (e.g., software) embodying or used by any one or more of the techniques or functions described herein. The instructions 724 can also reside, completely or at least partially, within any of registers of the hardware processor 702, the main memory 704, the static memory 706, or the mass storage device 708 during execution thereof by the machine 700. In an example, one or any combination of the hardware processor 702, the main memory 704, the static memory 706, or the mass storage device 708 can constitute the machine-readable media 722. While the machine-readable media 722 is illustrated as a single medium, the term “machine-readable medium” can include a single medium or multiple media (e.g., a centralized or distributed database, or associated caches and servers) configured to store the one or more instructions 724.

The term “machine readable medium” can include any medium that is capable of storing, encoding, or carrying instructions for execution by the machine 700 and that cause the machine 700 to perform any one or more of the techniques of the present disclosure, or that is capable of storing, encoding or carrying data structures used by or associated with such instructions. Non-limiting machine-readable medium examples can include solid-state memories, optical media, magnetic media, and signals (e.g., radio frequency signals, other photon-based signals, sound signals, etc.). In an example, a non-transitory machine-readable medium comprises a machine-readable medium with a plurality of particles having invariant (e.g., rest) mass, and thus are compositions of matter. Accordingly, non-transitory machine-readable media are machine readable media that do not include transitory propagating signals. Specific examples of non-transitory machine readable media can include: non-volatile memory, such as semiconductor memory devices (e.g., electrically programmable read-only memory (EPROM), electrically erasable programmable read-only memory (EEPROM)) and flash memory devices; magnetic disks, such as internal hard disks and removable disks; magneto-optical disks; and CD-ROM and DVD-ROM disks.

In an example, information stored or otherwise provided on the machine-readable media 722 can be representative of the instructions 724, such as instructions 724 themselves or a format from which the instructions 724 can be derived. This format from which the instructions 724 can be derived can include source code, encoded instructions (e.g., in compressed or encrypted form), packaged instructions (e.g., split into multiple packages), or the like. The information representative of the instructions 724 in the machine-readable media 722 can be processed by processing circuitry into the instructions to implement any of the operations discussed herein. For example, deriving the instructions 724 from the information (e.g., processing by the processing circuitry) can include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions 724.

In an example, the derivation of the instructions 724 can include assembly, compilation, or interpretation of the information (e.g., by the processing circuitry) to create the instructions 724 from some intermediate or preprocessed format provided by the machine-readable media 722. The information, when provided in multiple parts, can be combined, unpacked, and modified to create the instructions 724. For example, the information can be in multiple compressed source code packages (or object code, or binary executable code, etc.) on one or several remote servers. The source code packages can be encrypted when in transit over a network and decrypted, uncompressed, assembled (e.g., linked) if necessary, and compiled or interpreted (e.g., into a library, stand-alone executable etc.) at a local machine, and executed by the local machine.

The instructions 724 can be further transmitted or received over a communications network 726 using a transmission medium via the network interface device 720 utilizing any one of a number of transfer protocols (e.g., frame relay, internet protocol (IP), transmission control protocol (TCP), user datagram protocol (UDP), hypertext transfer protocol (HTTP), etc.). Example communication networks can include a local area network (LAN), a wide area network (WAN), a packet data network (e.g., the Internet), mobile telephone networks (e.g., cellular networks), plain old telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 720 can include one or more physical jacks (e.g., Ethernet, coaxial, or phone jacks) or one or more antennas to connect to the network 726. In an example, the network interface device 720 can include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 700, and includes digital or analog communications signals or other intangible medium to facilitate communication of such software. A transmission medium is a machine readable medium.

To better illustrate the methods and apparatuses described herein, such as can be used to help improve command scheduling in or for a memory device, a non-limiting set of Example embodiments are set forth below as numerically identified Examples.
Example 1 is a method for command scheduling in a memory controller, the method comprising: processing commands of a first command type from a command queue including transmitting data in a first direction using a data bus; turning around the data bus upon elapsing (e.g., in response to) a first phase time or first cycle limit, wherein turning around the data bus incurs a first number of idle data bus cycles, and following the idle data bus cycles, processing commands of a second command type from the command queue including transmitting data in a second direction using the data bus. In an example, Example 1 optionally includes determining whether the first phase time or first cycle limit elapsed and, in response, turning around the data bus.
In Example 2, the subject matter of Example 1 includes, turning around the data bus again upon elapsing a second phase time or second cycle limit, wherein turning around the data bus again incurs a second number of idle data bus cycles. In an example, Example 2 includes determining whether the second phase time or second cycle limit elapsed and, in response, turning around the data bus.
In Example 3, the subject matter of Example 2 includes, wherein the first and second number of idle data bus cycles are different.
In Example 4, the subject matter of Examples 1-3 includes, determining the first phase time or first cycle limit elapsed by comparing a phase timer or cycle counter value, respectively, to a stored reference or threshold value, such as a phase duration value.
In Example 5, the subject matter of Examples 1˜4 includes, wherein the commands of the first command type are exclusively read commands and wherein the commands of the second command type are exclusively write commands.
In Example 6, the subject matter of Examples 1-5 includes, interrupting the processing of commands of the first command type when the command queue includes only commands of the second command type, wherein interrupting the processing commands of the first command type includes turning around the data bus and processing commands of the second command type from the command queue.
Example 7 is a method for command selection by a memory controller, the method comprising: queuing multiple commands including read commands and write commands in a command queue; initiating a first read phase for a first duration and, during the first read phase, processing read commands from the command queue exclusively of write commands in the command queue, and sending read data in a first direction using a data bus; at expiration of the first duration, initiating a first write phase for a second duration, including turning the data bus around, processing write commands from the command queue exclusively of read commands in the command queue, and sending write data in a second direction using the data bus; and at expiration of the second duration, initiating a second read phase including turning the data bus around, and processing additional read commands from the command queue exclusively of write commands in the command queue, and sending read data in the first direction using the data bus.
In Example 8, the subject matter of Example 7 includes, receiving, at respective phase registers, duration information indicating a time duration or a cycle count of the first read phase and the first write phase.
In Example 9, the subject matter of Example 8 includes, wherein the duration information is the same for the first read phase and the first write phase.
In Example 10, the subject matter of Examples 8-9 includes, wherein the duration information is different for the first read phase and the first write phase.
In Example 11, the subject matter of Examples 8-10 includes, receiving, following expiration of at least one of the first and second durations, updated duration information for at least one of the phase registers.
In Example 12, the subject matter of Example 11 includes, wherein a duration of the second read phase corresponds to the updated duration information.
In Example 13, the subject matter of Examples 7-12 includes, wherein processing the read commands from the command queue exclusively of write commands includes: determining whether an unprocessed read command is available in the multiple commands; and responsive to determining no unprocessed read command is available, turning the data bus around during the first read phase, selecting a write command from the command queue, processing the selected write command, and sending write data for the selected write command in the second direction using the data bus.
In Example 14, the subject matter of Example 13 includes, receiving an indication of a new read command available in the command queue; and following the processing the selected write command, turning the data bus around again and processing the new read command.
In Example 15, the subject matter of Examples 7-14 includes, wherein processing the write commands from the command queue exclusively of read commands includes: determining whether an unprocessed write command is available in the multiple commands; and responsive to determining no unprocessed write command is available, turning the data bus around during the first write phase, selecting a read command from the command queue, processing the selected read command, and sending read data for the selected read command in the first direction using the data bus.
Example 16 is an apparatus comprising: a memory device; and a controller coupled to the memory device, wherein the controller comprises: a read phase register configured to store information about a read phase duration; a write phase register configured to store information about a write phase duration; a timer circuit; and command scheduling logic configured to select a particular read command or write command from a command queue based on a command phase, wherein the command phase alternates between a read phase and a write phase according to respective duration values stored in the phase registers and an elapsed time duration measured by the timer circuit, wherein the memory device is configured to exclusively process read commands during the read phase and exclusively process write commands during the write phase.
In Example 17, the subject matter of Example 16 includes, wherein the command scheduling logic includes: a multiplexer circuit coupled to the read phase register and the write phase register and configured to output a time limit corresponding to information in a selected one of the read phase register and the write phase register based on a phase-indicating signal; and a flip-flop circuit configured to provide the phase-indicating signal responsive to information about a relationship between the elapsed time duration from the timer circuit and the time limit from a multiplexer circuit; wherein the phase-indicating signal indicates the command phase.
In Example 18, the subject matter of Example 17 includes, wherein the command scheduling logic further includes first-ready, first-come, first-served (FRFCFS) logic configured to select the particular read command or write command for processing by the controller during the command phase.
In Example 19, the subject matter of Examples 17-18 includes, wherein the controller is configured to determine a read/write command ratio for commands in the command queue and, in response, update or adjust the duration values in one or both of the phase registers.
In Example 20, the subject matter of Examples 17-19 includes, wherein during a read phase, the command scheduling logic is configured to interrupt the read phase when the command queue is unoccupied by a read command, and the command scheduling logic is configured to interrupt the write phase when the command queue is unoccupied by a write command.
Example 21 is at least one machine-readable medium including instructions that, when executed by processing circuitry, cause the processing circuitry to perform operations to implement any of Examples 1-20.
Example 22 is an apparatus comprising means to implement of any of Examples 1-20.
Example 23 is a system to implement any of Examples 1-20.
Example 24 is a method to implement any of Examples 1-20.

Each of these non-limiting examples can stand on its own, or can be combined in various permutations or combinations with one or more of the other examples.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventor also contemplates examples in which only those elements shown or described are provided. Moreover, the present inventor also contemplates examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” can include “A but not B,” “B but not A,” and “A and B,” unless otherwise indicated. In the appended claims, the terms “including” and “in which” are used as the plain-English equivalents of the respective terms “comprising” and “wherein”. Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) can be used in combination with each other. Other embodiments can be used, such as by one of ordinary skill in the art upon reviewing the above description. It is submitted with the understanding that it will not be used to interpret or limit the scope or meaning of the claims. Also, in the above Detailed Description, various features can be grouped together to streamline the disclosure. This should not be interpreted as intending that an unclaimed disclosed feature is essential to any claim. Rather, inventive subject matter can lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A method for command scheduling in a memory controller, the method comprising:
processing commands of a first command type from a command queue including transmitting data in a first direction using a data bus;
turning around the data bus upon elapsing a first phase time or first cycle limit, wherein turning around the data bus incurs a first number of idle data bus cycles; and
following the idle data bus cycles, processing commands of a second command type from the command queue including transmitting data in a second direction using the data bus.

2. The method of claim 1, further comprising turning around the data bus again upon elapsing a second phase time or second cycle limit, wherein turning around the data bus again incurs a second number of idle data bus cycles.

3. The method of claim 2, wherein the first and second number of idle data bus cycles are different.

4. The method of claim 1, comprising determining the first phase time or first cycle limit elapsed by comparing a timer or counter value, respectively, to a stored phase duration value.

5. The method of claim 1, wherein the commands of the first command type are exclusively read commands and wherein the commands of the second command type are exclusively write commands.

6. The method of claim 1, comprising interrupting the processing of commands of the first command type when the command queue includes only commands of the second command type, wherein interrupting the processing commands of the first command type includes turning around the data bus and processing commands of the second command type from the command queue.

7. A method for command selection by a memory controller, the method comprising:
queuing multiple commands including read commands and write commands in a command queue;
initiating a first read phase for a first duration and, during the first read phase, processing read commands from the command queue exclusively of write commands in the command queue, and sending read data in a first direction using a data bus;
at expiration of the first duration, initiating a first write phase for a second duration, including turning the data bus around, processing write commands from the command queue exclusively of read commands in the command queue, and sending write data in a second direction using the data bus; and
at expiration of the second duration, initiating a second read phase including turning the data bus around, and processing additional read commands from the command queue exclusively of write commands in the command queue, and sending read data in the first direction using the data bus.

8. The method of claim 7, comprising receiving, at respective phase registers, duration information indicating a time duration or a cycle count of the first read phase and the first write phase.

9. The method of claim 8, wherein the duration information is the same for the first read phase and the first write phase.

10. The method of claim 8, wherein the duration information is different for the first read phase and the first write phase.

11. The method of claim 8, comprising receiving, following expiration of at least one of the first and second durations, updated duration information for at least one of the phase registers.

12. The method of claim 11, wherein a duration of the second read phase corresponds to the updated duration information.

13. The method of claim 7, wherein processing the read commands from the command queue exclusively of write commands includes:
determining whether an unprocessed read command is available in the multiple commands; and
responsive to determining no unprocessed read command is available, turning the data bus around during the first read phase, selecting a write command from the command queue, processing the selected write command, and sending write data for the selected write command in the second direction using the data bus.

14. The method of claim 13, comprising:
receiving an indication of a new read command available in the command queue; and
following the processing the selected write command, turning the data bus around again and processing the new read command.

15. The method of claim 7, wherein processing the write commands from the command queue exclusively of read commands includes:
determining whether an unprocessed write command is available in the multiple commands; and
responsive to determining no unprocessed write command is available, turning the data bus around during the first write phase, selecting a read command from the command queue, processing the selected read command, and sending read data for the selected read command in the first direction using the data bus.

16. An apparatus comprising:
a memory device; and
a controller coupled to the memory device, wherein the controller comprises:
a read phase register configured to store information about a read phase duration;
a write phase register configured to store information about a write phase duration;
a timer circuit; and
command scheduling logic configured to select a particular read command or write command from a command queue based on a command phase, wherein the command phase alternates between a read phase and a write phase according to respective duration values stored in the phase registers and an elapsed time duration measured by the timer circuit, wherein the memory device is configured to exclusively process read commands during the read phase and exclusively process write commands during the write phase.

17. The apparatus of claim 16, wherein the command scheduling logic includes:
a multiplexer circuit coupled to the read phase register and the write phase register and configured to output a time limit corresponding to information in a selected one of the read phase register and the write phase register based on a phase-indicating signal; and
a flip-flop circuit configured to provide the phase-indicating signal responsive to information about a relationship between the elapsed time duration from the timer circuit and the time limit from a multiplexer circuit;
wherein the phase-indicating signal indicates the command phase.

18. The apparatus of claim 17, wherein the command scheduling logic further includes first-ready, first-come, first-served (FRFCFS) logic configured to select the particular read command or write command for processing by the controller during the command phase.

19. The apparatus of claim 17, wherein the controller is configured to determine a read/write command ratio for commands in the command queue and, in response, update or adjust the duration values in one or both of the phase registers.

20. The apparatus of claim 17, wherein during a read phase, the command scheduling logic is configured to interrupt the read phase when the command queue is unoccupied by a read command, and the command scheduling logic is configured to interrupt the write phase when the command queue is unoccupied by a write command.
